(19) United States
(12) Patent Application Publication
(10) Pub. No.: US 2003/0025457 A1
(43) Pub. Date: Feb. 6, 2003

(54) Lighting system utilizing cylindrical lens and fluorescent lamps designed for specific use in aquarium and desk lighting applications

(76) Inventor: Chen-Yu Tai, Holland, OH (US)

Correspondence Address: CHEN-YU TAI, 16 TREMORE WAY, HOLLAND, OH, 43528, US

(21) Appl. No.: 09/898,974

(22) Filed: Jul. 5, 2001

(51) Int. Cl. G05F 1/00

(52) U.S. Cl. 315/61; 315/291

(57) ABSTRACT

An assembly especially suitable for aquarium and desk lighting or other such arrangement requiring lighting of only a limited area is disclosed herein. This lighting assembly is composed of one or more miniature fluorescent lamps, reflector arrangement and cylindrical lens to provide lighting with a controllable degree of collimation. This lighting system can illuminate a desired area with light of multiple colors. Applications of this compact and energy efficient lighting system in aquarium and desk lighting are described.

Cross Reference to Related Applications
U.S. Pat. No. Documents

| | | | |
|---|---|---|---|
| 3069579 | December, 1962 | Berg et al. | 313/511. |
| 3609343 | September, 1971 | Howlett | 362/562. |
| 3749901 | July, 1973 | Clough | 362/562. |
| 3819973 | June, 1974 | Hosford | 313/498. |
| 3908598 | September, 1975 | Jewson | 119/267. |
| 4516529 | May, 1985 | Lotito et al. | 119/253. |
| 5067059 | November, 1991 | Hwang | 362/101. |
| 5211469 | May, 1993 | Matthias et al. | 362/101. |
| 5353746 | October, 1994 | Del Rosario | 119/266. |
| 5546289 | August, 1996 | Gordon | 362/101. |
| 5848837 | December, 1998 | Gustafson | 362/101. |
| 6,074,072 | December, 1998 | Gustafson | 362/101. |
| 6,203,173 | February, 1999 | Baumberg et al. | 313/506. |

### BACKGROUND OF THE INVENTION

This Invention relates to high brightness lighting systems with the output light beams collimated to have a predetermined divergent angle. This lighting system is especially suitable for applications where a limited area, such as an aquarium tank, needs illumination.

Most of the aquariums need to have some lamp or lighting means to illuminate the tank so that fish in the tank and their movements are readily visible. For salt water fish and coral, very high brightness and dual color (blue and white) lighting is required. Current aquarium lighting systems have a number of disadvantages when used at home, office, or other places. One such problem is energy efficiency. Most of the current high brightness aquarium lighting systems use inefficient standard fluorescent lamps (with a diameter of 0.5″ or wider), or metal halide lamps. Furthermore, light output from the existing lighting systems have a very broad divergent angle. Without means to sufficiently collimate, or focus, the light beams to illuminate only the tank, and with inefficient lamps, high power is required to reach the desired brightness. Certain current aquarium lighting systems may use two to three metal halide lamps of 175 W each. The high power lamps generate a lot of heat and a fan is often required to dissipate the excess heat. A second problem with the aquarium lighting systems in the market is safety. With the high power and high voltage (120V ac) lamps operating near water, these lighting systems cause safety concerns. In addition, the very high temperature associated with the metal halide lamp may cause fires.

### SUMMARY OF THE INVENTION

In many lighting applications, such as aquarium lighting, desk lighting, and tanning, only a limited area needs to be lit. To achieve a high efficiency in illuminating the area, one needs to use a very high efficient light source and to have the output light collimated, or focused, to illuminate only the area of interest, so that energy waste will be minimized.

The Invention is extremely efficient and is especially suitable for aquarium and desk lighting applications, because it overcomes, for the most part, the above disadvantages of conventional tank lighting systems. The Invention uses very thin and extremely efficient small diameter fluorescent lamps (or “miniature” fluorescent lamp, with a diameter less than ¼″) as the light source. To further increase the efficiency of the Invention, a reflector (or, reflectors) and a cylindrical lens (or cylindrical lenses) are used to focus light beams from the fluorescent lamp (or lamps) to a desired divergent angle so that only the fish or coral will be lit.

This Invention provides dual color operation when fluorescent lamps of different colors (such as blue and white) are installed in this lighting system. The aquarium lighting system application of the present Invention requires only a fraction of the power of the metal halide lamp to reach the same brightness. As a result, it generates very little heat and requires no cooling fan. In an embodiment described in this invention, input electric voltage to this lighting system is 12 V dc. This device therefore provides a safe aquarium lighting system as compared to existing products in the market. The Invented lighting system can provide dual, or multiple color lighting.

The Invention can also be used in other applications, such as desk lamps, and tanning lighting, where only a certain area needs to be lit.

### DESCRIPTION OF THE DRAWINGS

FIG. 1 is the lighting system according to an embodiment of the Invention;

FIG. 2 is a cross sectional view of the optical arrangement for the lighting system according to the first embodiment of this Invention;

FIG. 3 is a simplified diagram to demonstrate light propagation and collimation in FIG. 2;

FIG. 4 is a cross sectional view showing the required divergent angle of light beams to illuminate the whole bottom surface of an aquarium tank;

FIG. 5 is a cross sectional view of a second embodiment of this Invention;

FIG. 6 is a simplified diagram of FIG. 5 to demonstrate light propagation and collimation in this embodiment;

FIG. 7 is the lighting system according to the third embodiment of this Invention;

FIG. 8 is the lighting system according to the fourth embodiment of this Invention;

FIG. 9A is the cross sectional view of the optical arrangement for the lighting system according to the fourth embodiment;

FIG. 9B is the cross sectional view of the optical arrangement for the lighting system according to a fifth embodiment;

FIG. 10 is the lighting system according to the sixth embodiment of this invention;

FIG. 11 is an aquarium with the Invention placed on the top of the water tank;

FIG. 12 is an aquarium with the Invention hanging over the water tank;

FIG. 13 is an aquarium with the Invention located underneath the water tank.

FIG. 14 is an aquarium with the invented lighting system located inside the water tank.

FIG. 15 is the invented lighting system used as a desk lamp.

### DESCRIPTION OF THE PREFERRED EMBODIMENTS

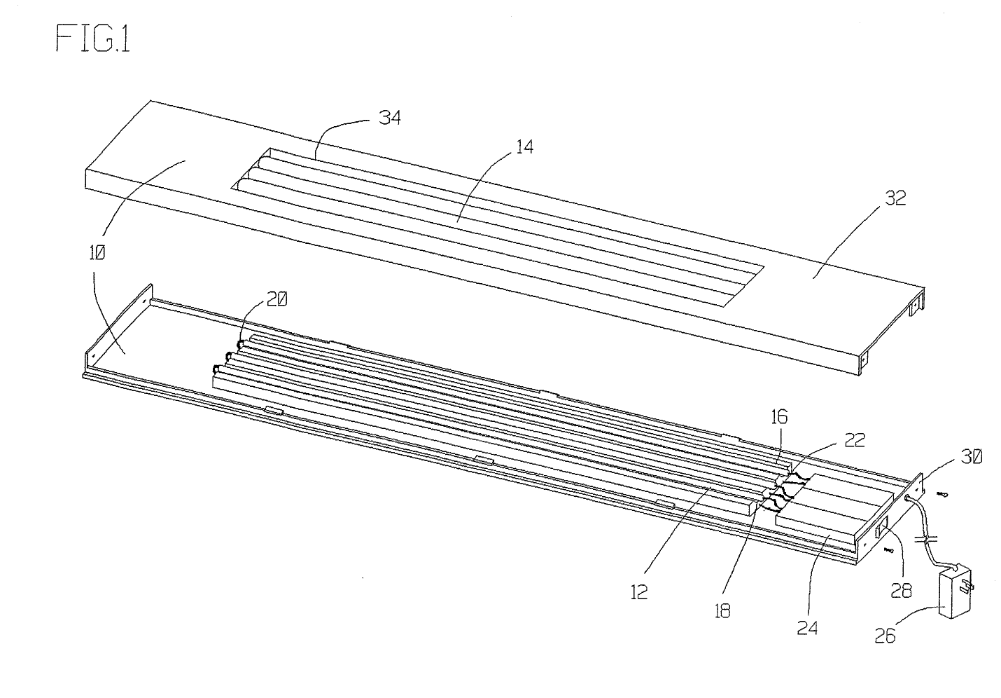

Referring now to drawings, wherein like components are designated by the like reference numerals throughout the various figures, attention is directed to FIG. 1 which shows a lighting system 10 using miniature fluorescent lamps 12 as the light source, and cylindrical lens 14 to focus light beams. Each fluorescent lamp sits in a “groove” 16 on a lamp holder 18. Electrodes 20 and 22 of each CCFL lamp 12 are connected to an inverter 24 which provide power for the lamp 12. Output from the inverter 24 is typically several hundred volts. The current is typically a few mA for each fluorescent lamp. The frequency is typically 10 to 100 kHz. . Power consumption for each lamp is typically 2 to 5 watts. Input voltage to the inverter 24 in this particular example is 12V. However, certain inverters may have input voltages of 2V to 24V. Each inverter 24 in FIG. 1 provides power to one fluorescent lamp. There are, however, commercially available inverters that can power several lamps. FIG. 1 also shows a switching power adaptor 26 that converts 110-120V ac from the wall power outlet to 12 V dc for the inverter 24. An on/off switch 28 is installed between the switching power adaptor 26 and the inverters 24. BACKGROUND The lamp holder 18, the lamps 12 and the inverters 24 are installed on a chassis base unit 30. The cover unit of the chassis 32 has a window 34. In this embodiment, the cylindrical lenses 14 are attached to the cover plate 32.

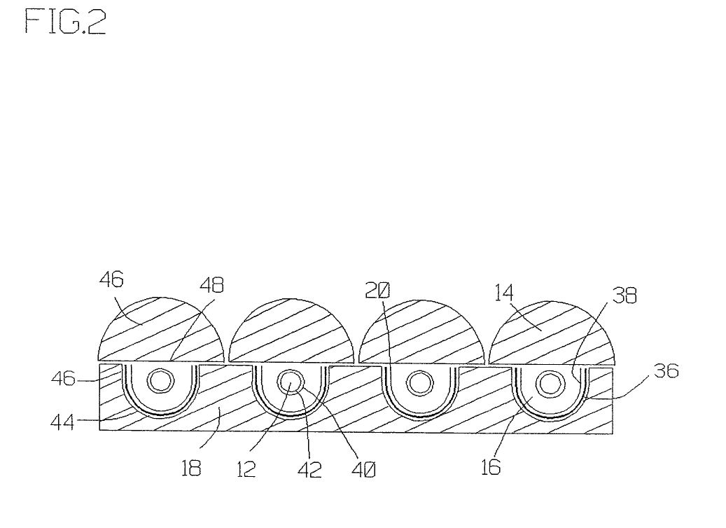

Turning now to FIG. 2, a sectional view is depicted of the optical arrangement for this BACKGROUND lighting device. In this arrangement, the groove 16 on the lamp holder 18 has a mirror like reflective surface 36. In the particular embodiment, this reflective surface 36 is a thin layer of highly reflective metal, such as silver or aluminum, coated on the surface of the groove 16. A transparent protective layer 38 is added to the top of the reflective metal layer 36 to prevent scratch or oxidization of the metal layer. This BACKGROUND transparent protective layer 38 can be a layer of paint spread on the metal layer 20. Since metal is a good electric conductor and the fluorescent tube is operated with a high voltage at high frequency, this protective coating 38 also provides electric insulation between the lamp 12 and the metal layer 36. The lamp holder 18 in this embodiment is made of polycarbonate, or acrylic material.

In the embodiments shown in FIG. 2, the fluorescent lamp 12 has a diameter of 2.6 mm and a length of 380.0 mm. The glass wall 40 of the lamp 12 has a thickness of 0.3 mm and the light emitting area, the inner surface 42 of the glass wall, has a diameter of 2.0 mm. The groove 16 in the lamp holder has a maximum width of 8.0 mm and a depth of 6.0 mm. The configuration of the groove 16 is composed of a semi-circle 44 with a radius of 4.0 mm and BACKGROUND two sections of vertical lines 46 extending from the edge of the semi-circle upwards towards the cylindrical lens 14. The cylindrical lens 14 has a cross section of a semi-circle 46 with a radius of 12.0 mm and a flat surface 48. In this embodiment, the cylindrical lens 14 is made of acrylic. In the optical arrangement, the center of the miniature fluorescent lamp 12 is located at a distance of 0.7 mm from the bottom of the groove 16.

We will now demonstrate the focusing of light beams emitting from the miniature fluorescent lamps in this lighting assembly. The easiest method to demonstrate light propagation is to use geometric optics. Although the dimension (radius) of the fluorescent tube (the lamp) is not negligible as compared to the dimension of the lens and the reflecting grooves, this simplified classical geometric optics approach can still demonstrate reasonably well the principle of this optical arrangement.

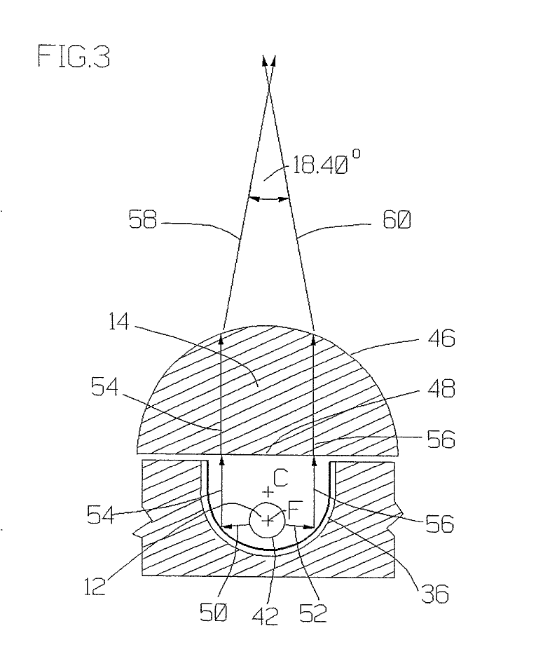

FIG. 3 is a simplified diagram showing light propagation in this arrangement from one of the lamp-groove-lens arrangement. In FIG. 3, the slim light emitting area 42 (the inner surface 42 of the glass wall 40) of the fluorescent lamp 12 is a small circle with a diameter of 2.0 mm, in this two dimensional drawing. The reflecting surface 36 in the groove 16 is a spherical mirror with a radius of 4.0 mm and a focal length of 2.0 mm. The 48 of the cylindrical lens 14. With the width of the groove 18 propagation center of the curvature of the groove is designated as point C in the diagram. The focal point of the mirror is designated as F in FIG. 3. As shown in FIG. 3, the light source is located around the focal point F of the mirror. Light beams 50 and 52 from the lamp will be reflected by the mirror, and propagate as parallel light beams 54 and 56 towards the flat surface equal to 8.0 mm, the light beams will have a “diameter” of 8.0 mm. The propagation direction of the light beams will not change when they enter the lens 14 through the flat surface 48.

We will now discuss propagation of the light beams through the spherical surface 46 of the cylindrical lens 14. According to the formula for image formation by a spherical refracting surface (Ref. To “Physics”, Chapter 42, Page 971, by David Holiday and Robert Resnick, Third Edition, Part 2, Published by John Wiley & Sons, New York, 1978):

n₁/o+n₂/i=(n₁−n₂)/r (1)

Here n₁ is the index of refraction of the acrylic (=1.49) and n₂ is the index of refraction of air (=1). The distance of the object from the refracting surface 46 is o. The distance of the image from the refracting surface 46 is i. The radius of the refracting surface 46 is r. For parallel light beams, the object distance, o, is infinity. The image is therefore located at:

i=rn₂/(n₁−n₂)≈2r.

With r=12.0 mm, i≈24.0 mm. Since the light beams have a diameter of 8.0 mm before they are focused to point i , the light beams will have a maximum divergent angle of 18.4° when the beams 60, 62 are propagating towards the lighting object.

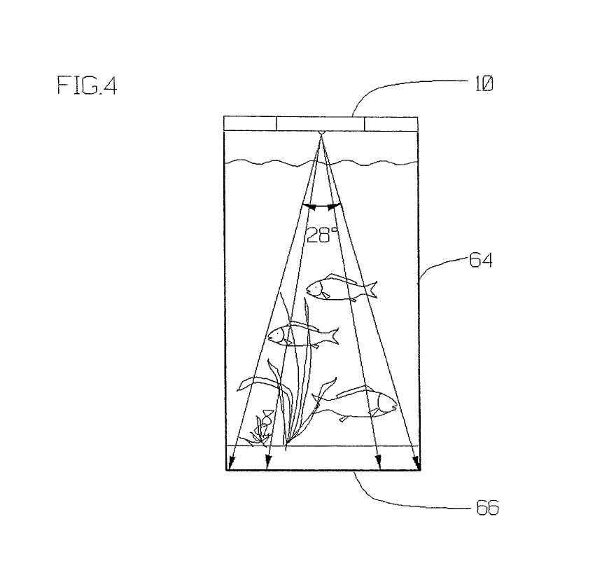

FIG. 4 shows the cross sectional view of light propagating with the lighting assembly placed on top of a water tank 64. A typical aquarium tank has a height of approximately 24.0″ and a width of 12.0″. Light beams need to have a full divergent angle of 28° to illuminate the full width of the bottom surface 66 of the tank. The optical arrangement, shown in FIG. 3, will therefore have light beams focused tighter than necessary. The real lighting assembly, shown in FIG. 2, usually provides a wider light beam divergent angle than the value that we calculated above, since the lamp is not a line light source. Since the lamp is not a point light source in the two dimensional diagram FIG. 3, output light beams will have a non-zero divergent angle. The divergent angle of the light beams may be increased by adjusting the location of the fluorescent lamps 12 relative to the focal point of the mirror, the groove 16.

Here it should be pointed out that essentially all of the natural light, including sun light and moon light, are highly collimated. An aquarium light source which provides collimated light beams will therefore be desirable, since it creates shadows and exaggerates any movements in the aquarium. Shadows of the waters gentle ripples will undulate across a reef under the light, and thereby will closely recreate the natural scenery.

The reflective metal layer in this embodiment can be sandwiched between two layers of transparent material to form a reflective film. This reflective film is then glued to the lamp holder. A silver reflective film, made by 3M and sold as “Silverlux”, is particularly suitable for this arrangement. Reflectivity of the Silverlux is approximately 95%. It has “glue” on one side and can be easily “glued” to the lamp holder.

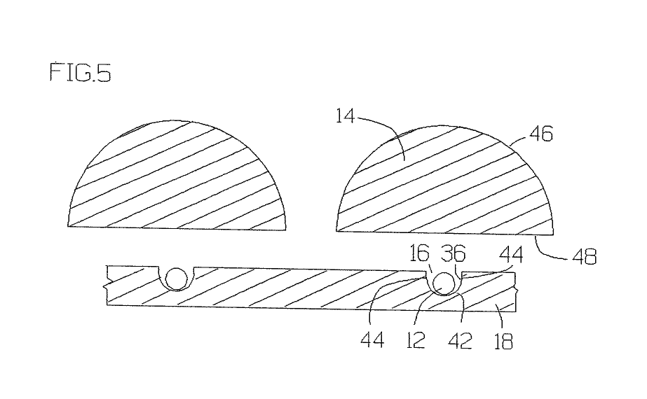

The cross sectional diagram of the optical system of a second embodiment of this invention is shown in FIG. 5. In this embodiment, the reflecting surface is a high reflectivity white surface. In the diagram shown in FIG. 5, the groove surface 36 is a highly reflective white surface. In this embodiment, the lamp holder is a white acrylic plate. The groove 18 in the lamp holder has a maximum width of 4.0 mm and a depth of 2.6 mm. The configuration of the groove 16 is composed of a semi-circle 42 with a radius of 2.0 mm and two vertical sections 44 with a length of 0.6 mm. The cylindrical lens 14 has a cross section of a semi-circle surface 46 with a radius of 6 mm and a flat surface 48. In the optical arrangement, the center of the CCFL lamp 12 sits on the bottom surface of the groove 16. The focusing lens 14 sits at a distance of 8.0 mm above the lamp holding plate 18.

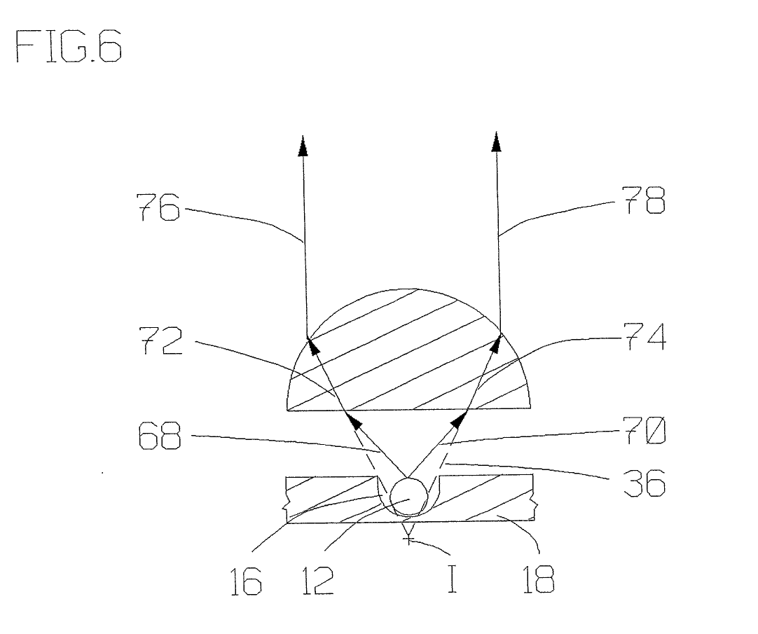

Now we will discuss propagation of light beams by lighting assemblies FIG. 5. The white layer of material reflects light in random directions. To simplify the discussion, light beams from the lamp 12 and the white reflecting surface 36 of the groove 16 can be regarded as a light emitting object located at the top of the groove/lamp combination and has a width of 4.0 mm. With the arrangement shown in FIG. 6, this light emitting object is located at a distance 8.0 mm from the flat surface of the cylindrical lens. With formula (1) of image formation, it is very easy to find that the image I formed by this refraction flat surface is located at a distance of approximately 12.0 mm from the first surface. Light beams 62 and 64 emitted from the lamp (or the surrounding area) will be “bent by the first surface. The bent beams 66 and 68 propagate in a direction which seems to originate from the image I. To the second surface of the lens, this image is an object located at a distance approximately 18.0 mm from the surface. It is very easy to see that this image I is located at approximately the focal point of this curved surface 46 and output light from this lens propagates as parallel beams 70, 72 in the simplified analysis. In the real system described in FIG. 5, output light will not be totally collimated (to become parallel light beams). Light beams 70 and 72 exiting this lighting system will have a small, but not zero, divergent angle. By adjusting the position of the lamps (height) with respect to the lens, output light with a desired divergent angle may be achieved.

In the second embodiment of this invention discussed above, the reflecting white surface of the groove may also be a layer of white paint. Another arrangement to achieve a highly reflective white surface in the groove is to coat the groove with a reflective film, such as a 0.25 mm thick DRP reflective material made by W. L. Gore & Associates Inc. (Elkton, Md.).

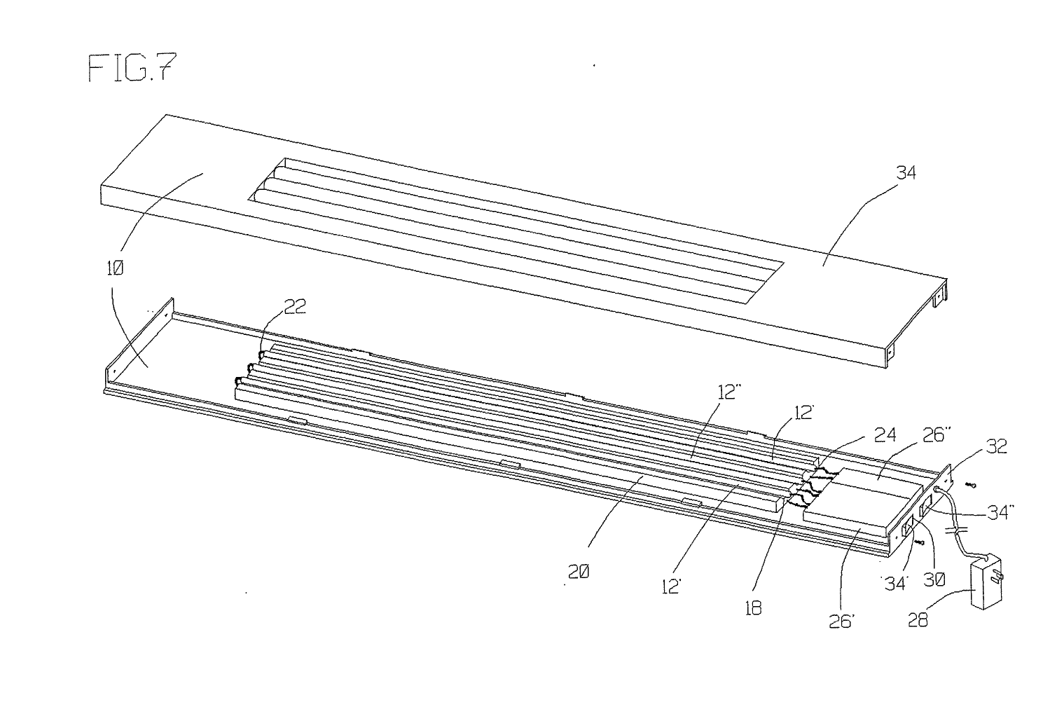

FIG. 7. shows a third embodiment of this invention where lamps of two colors, 12′ and 12″, are used to provide a dual color aquarium lighting. This unit also has two inverters 26′ and 26″ and two switches 34′ and 34″ connected to lamps 12′ and 12″ respectively. Lamps of the two colors can therefore be independently turned on and off. There are three fluorescent lamps, two giving white light and one giving blue light, used in the backlight system shown in FIG. 7. However, we do not wish to limit the number of lamps to three and the number of colors to two. This invention may be easily extended to use more (or less) lamps to give multiple color lighting.

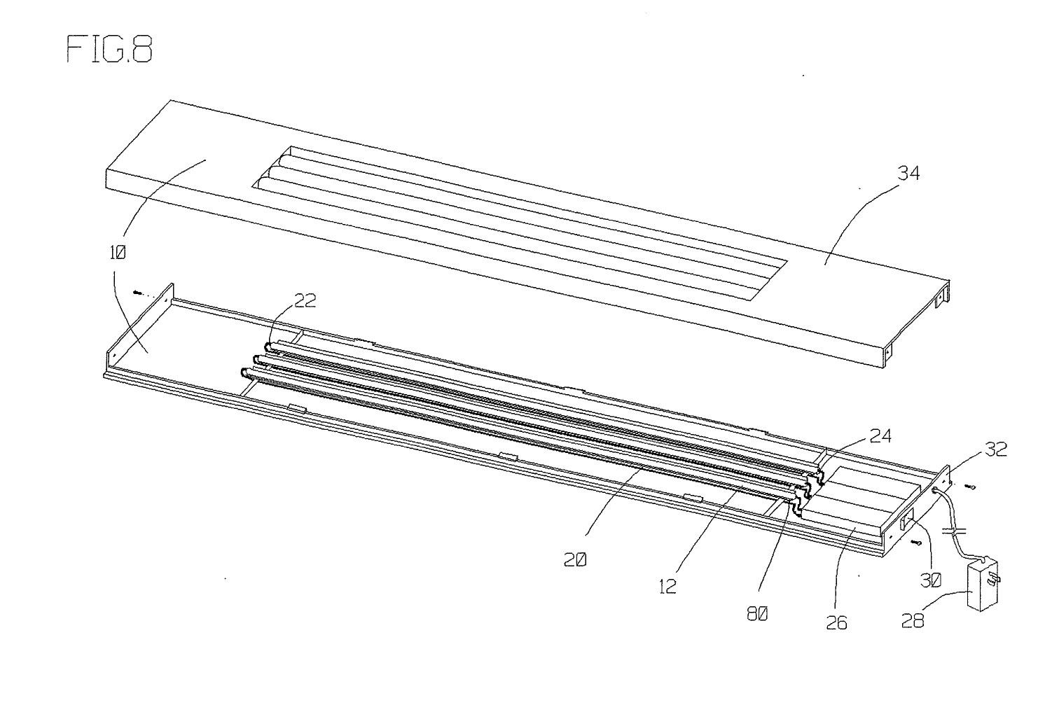

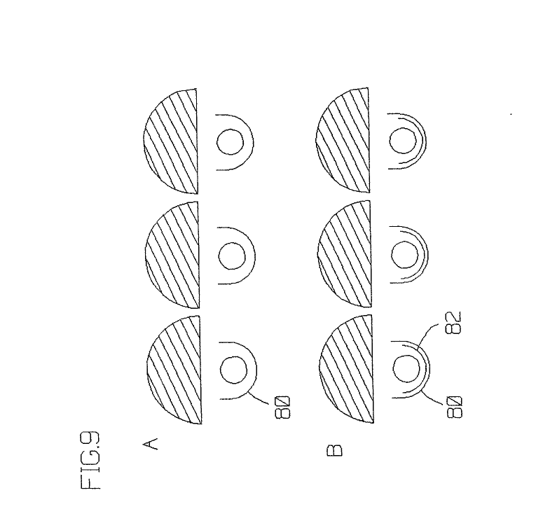

FIG. 8 shows a fourth embodiment of this invention. In this invention, the lamp holder 18 and groove 16 assembly, shown in FIG. 1, is replaced by a group of lamp holders 80. In the embodiment shown in FIG. 8, this lamp holder 80, consists of bent thin metal strips with a U-shape cross section. FIG. 9A is a cross sectional view of this lamp holder 80 which has a polished metal surface (or, coated surface) to work as a mirror. FIG. 9B shows the cross sectional view of the lamp holder with a highly reflective white film 82 attached to the metal surface of the lamp holder 80 to provide the diffusive reflective surface.

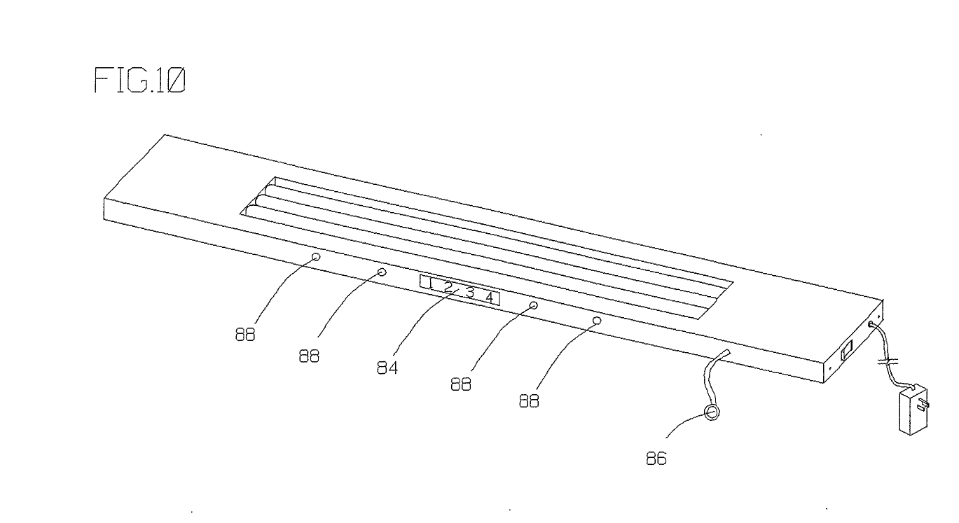

FIG. 10 shows a fifth embodiment of this invention which is a programmable collimated lighting system. This lighting system has a microprocessor (NOT SHOWN), a flat display 84, a timer (not shown), a light sensor 86, and knobs, or push buttons 88 to set the settings, and an optical sensor 76 installed in the lighting system. With the microprocessor, this unit may be programmed to have the light's color and intensity varied to synchronize it with the outdoor lighting condition, or to simulate the outdoor lighting condition.

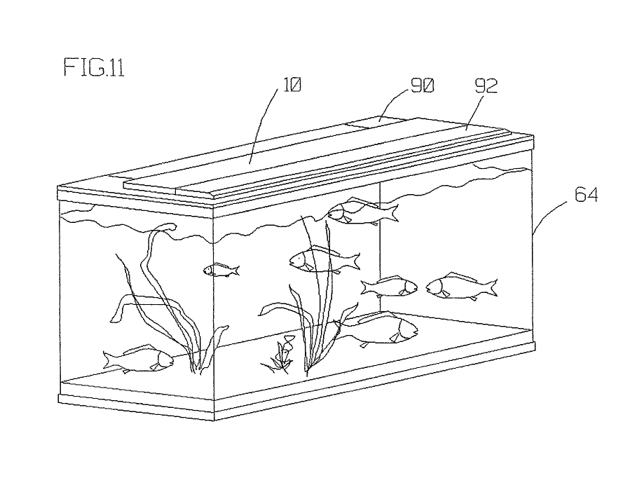

Now, we will describe arrangements to illuminate an aquarium with the Invention. FIG. 11 shows an aquarium with this lighting system installed in a hood, or canopy 90 which is placed on top of an aquarium water tank 64. This hood fits over the top edges of the side walls of the water tank, and also has a lid 92 that can be opened. Here it should be noticed that a certain aquarium lighting system in the market has a removable lighting assembly. The Invention can be made as a replacement unit for the removable lighting assemblies in the market.

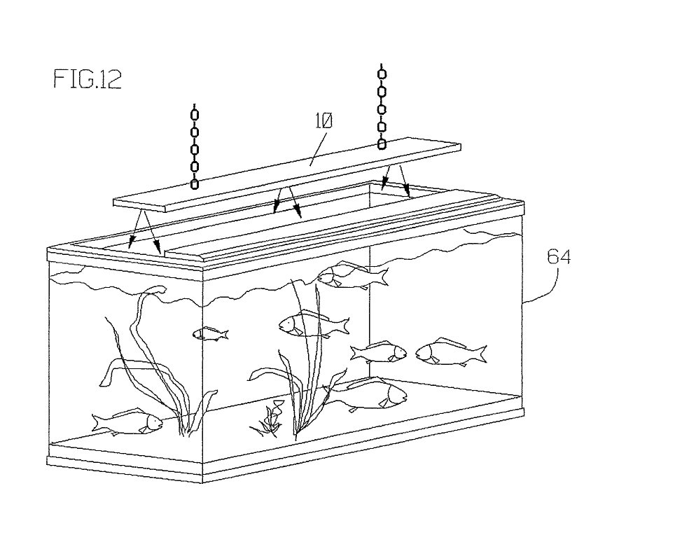

FIG. 12 shows another arrangement in which the invented lighting system 10 is hanging above an aquarium tank 64 which has a transparent cover.

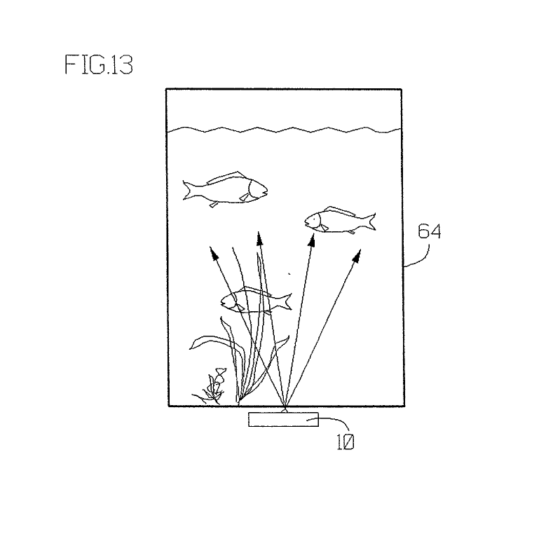

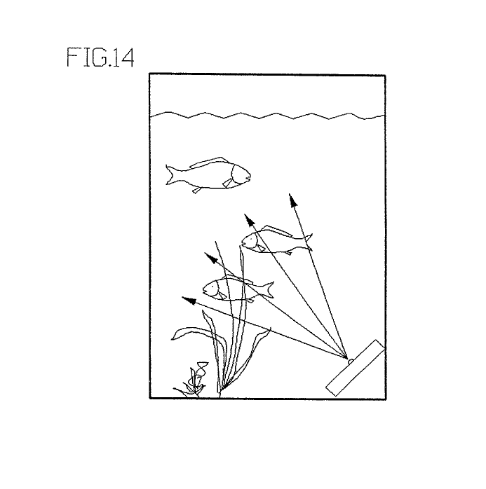

FIG. 13 is a cross sectional view of yet another arrangement in which the Invention 10 is placed underneath the tank 64. With this arrangement, light illuminates mainly the deep side of the tank. FIG. 14 shows another arrangement in which the lighting assembly is watertight, and is placed inside the aquarium water tank. The lighting system is placed closer to the viewing side and is tilted. With this arrangement, there is very little stray light directed towards the viewer to distract attention and the illuminating light shines mainly upon the deep water area. This arrangement will therefore highlight fish, coral, and plants with a sharp contrast.

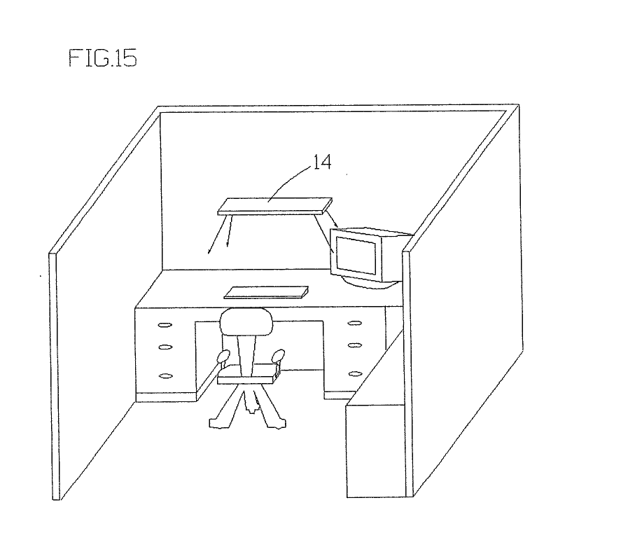

The Invention is also suitable for other applications requiring only a limited area to be illuminated. FIG. 15 shows a desk in a cubical in an office illuminated with the invented

What is claimed is:

1. An aquarium lighting system with output light beams focused to a predetermined divergent angle, comprising;
(a) An enclosure having opposing top and bottom surfaces which define the thickness of said lighting system, opposing sides define the width of said lighting system, opposing ends which define the length of said lighting system, and a window;
(b) lamp holder with a groove which has a reflective surface;
(c) a fluorescent lamp sits in the said groove;
(d) a cylindrical lens;
(e) an electronic element to provide electric power for the fluorescent lamp.

2. An aquarium lighting system as recited in claim 1 wherein said reflective surface is a mirror like reflecting surface.

3. An aquarium lighting system as recited in claim 1 wherein said reflective surface is a diffusive white surface.

4. An lighting system as recited in claim 1 wherein said electronic element is an inverter which converts dc current to ac current.

5. An lighting system as recited in claim 1 further comprising a microprocessor which can be programmed to provide a variable level of brightness of the light from the lighting system.

6. An lighting system as recited in claim 1 further comprising an optical sensor.

7. An aquarium lighting system as recited in claim 1 further comprising a second fluorescent lamp to provide lighting with a second color.

8. An aquarium with the said lighting system in claim 1.

9. An aquarium as recited in claim 8 wherein said lighting system is located above the aquarium water tank.

10. An aquarium as claimed in claim 9 where the said lighting system is located underneath the water tank.

11. An aquarium as claimed in claim 10 where said lighting system is located inside the water tank of the aquarium.

12. A lighting system comprising;
(a) an enclosure having opposing top and bottom surfaces which define the thickness of said lighting system, opposing sides define the width of said lighting system, opposing ends which define the length of said lighting system, and a window;
(b) a lamp holder with a groove which has a reflective surface;
(c) a fluorescent lamp sits in the said groove;
(d) a cylindrical lens placed between the fluorescent lamp and the said window, and
(e) an electronic element to provide electric power for the fluorescent lamp.

13. A lighting system as recited in claim 12 wherein said reflective surface is a mirror like reflecting surface.

14. A lighting system as recited in claim 12 wherein said reflective surface is a white surface.

15. A lighting system as recited in claim 12 wherein said electronic element is an inverter which converts dc current to ac current.

16. A lighting system as recited in claim 12 further comprising a second fluorescent lamp to provide lighting with a second color.

17. A desk lighting system composing:
(a) an enclosure having opposing top and bottom surfaces which define the thickness of said lighting system, opposing sides define the width of said lighting system, opposing ends which define the length of said lighting system, and a window;
(b) a lamp holder with a groove which has a reflective surface;
(c) a fluorescent lamp sits in the said groove;
(d) a cylindrical lens placed between the fluorescent lamp and the said window, and
(e) an electronic element to provide electric power for the fluorescent lamp.
